(19) United States
(12) Patent Application Publication
(10) Pub. No.: US 2003/0172178 A1
(43) Pub. Date: Sep. 11, 2003

(54) Method to avoid high-level data link control (HDLC) frame abortion

(76) Inventors: Eduard Lecha, Emeryville, CA (US); Juan-Carlos Calderon, Fremont, CA (US)

Correspondence Address: Pillsbury Winthrop LLP, Intellectual Property Group, 1600 Tysons Boulevard, McLean, VA, 22102, US

(21) Appl. No.: 10/096,117

(22) Filed: Mar. 8, 2002

(51) Int. Cl. G06F 15/16

(52) U.S. Cl. 709/236; 709/201

(57) ABSTRACT

A system to generate and transfer data frames without frame abortion includes an input source to provide input characters to transmit. A frame writing device generates the data frames having the input characters, stuffed characters, and non-data characters. The frame writing device inserts the stuffed characters into the data frames in place of the input characters that are identical to predetermined special characters utilized in the data frames. No more than two different special characters are utilized in the data frames. A frame transmitting device transmits the data frames. A frame receiving device receives the data frames. A data extraction device extracts the input characters from the data frames. The data extraction device extracts the input characters from the stuffed characters.

### BACKGROUND OF THE INVENTION

1. Field of the Invention

This invention relates to the field of data transmission, and more specifically, to a system, method, and apparatus for “stuffing” a minimal number of characters of data to prevent a generated frame of data from being aborted when a device generating the frames encounters data underflow.

2. Discussion of the Related Art

Networks such as the Internet, Local Area Networks (LANs), or Wide Area Networks (WANs) typically transmit data between devices via frames of data. High-level Data Link Control (HDLC), International Organization for Standardization/International Electrotechnical Convention (ISO/IEC) 3309, published Jun. 1, 1991, is an International Organization for Standardization (ISO) communications protocol used in X.25 packet switching networks. HDLC provides error correction at the data link network. Networks often use the HDLC protocol when transmitting frames.

Internet devices communicate data via Packet Over Synchronous (POS) Optical NETwork, or SoNET, frames in the Synchronous Optical Networks/Synchronous Digital Hierarchy (SONET/SDH) payload. Internet Protocol (IP) packets are encapsulated into Point-to-Point Protocol (PPP) frames that are encapsulated in HDLC-like frames when mapped into SONET/SDH. POS is specified by the Internet Engineering Task Force (IETF) in (a) “PPP in HDLC-like Framing”, RFC 1662, published July 1994; (b) “PPP over SONET/SDH”, RFC 2615, published June 1999; and (c) “IP Over SDH Using LAPS”, International Telecommunication Union (ITU)-T X.85, published March 2000.

A device transmitting a frame of data can create the frame from an input stream of data. The frame can then be transmitted across the network. The frames are typically made on a continual basis. However, a problem arises if a frame is being made but no data has been received via the input stream. For example, if a device creating frames creates and transmits one frame every 0.025 seconds, but there is a gap in the input data stream of 0.03 seconds when no data is received, then the device creating the frame has insufficient data with which to create the frame. Under traditional HDLC methods, the frame would be aborted because of the insufficient data. However, the abortion of frames results in system slowdown and poor performance, because many systems utilize devices to create frames that operate more quickly than data is received from the data stream. In such scenarios, many frames are aborted, resulting in subpar system performance.

Some systems have been implemented to prevent frame abortion. For example, some systems insert a special filler character into a frame to take up space. The filler character is treated as a NULL, and has no value when the frame is received and data is extracted therefrom. FIG. 1 shows a method that has been used in the prior art to avoid the frame abortion. An input data stream 100 is utilized to form a data frame 105 to send through the network. As illustrated, the data stream 100 includes several different characters. “U,” “X” “Y,” and “Z” all represent data characters in the input stream 100. There are situations in which characters “X,” “Y,” and “Z” are used in frames 105 for functions other than data representation. For example, “Y” can be used to represent the starting point of a frame 105. Therefore, “Y” cannot also occur as a data representation in the frame 105. “X,” “Y,” and “Z” are known as “special characters” in the frame 105 because they do not represent data. In order to transmit the data represented by the “X” character in the data stream, the character has to be altered from its present state before being added to the frame 105. Several methods alter such characters by utilizing a “stuffing” process. Stuffed characters are data representations that are slightly altered from the original, unstuffed characters. Stuffed characters often also have another character associated with them that signifies they are stuffed bits. Whenever “X,” “Y”, or “Z” are present in the data stream, they must be stuffed before they can be added to a frame of data.

As shown, the “U” character is the only character in the data stream 100 not stuffed. “X” is stuffed, replaced with “X” and “SBX,” “Y” is stuffed, replaced with “K” and “SBY,” and “Z” is stuffed, replaced with “X” and “SBZ”. The filler “Z” is also added to the frame. The filler “Z” is inserted into the frame 105 to prevent frame abortion when the frame 105 is being generated, but insufficient data has been input from the input data stream 100. It is inefficient to use three special characters in a frame 105, because they must all be stuffed. The more times “Z” appears in the data, the longer the frame becomes. As shown, the frame 105 including the stuffed bits can become long.

Therefore, the prior art is deficient because HDLC-compatible frames often abort unless they include filler characters. Also, the prior art is inferior because three or more special characters are used in frames, and when those characters are present in a data stream 100, those characters all have to be represented by stuffed characters in the frame, resulting in larger frames and an overall slowdown of system processing.

### BRIEF DESCRIPTION OF THE DRAWINGS

FIG. 1 illustrates a data frame generated from a data stream according to the prior art;

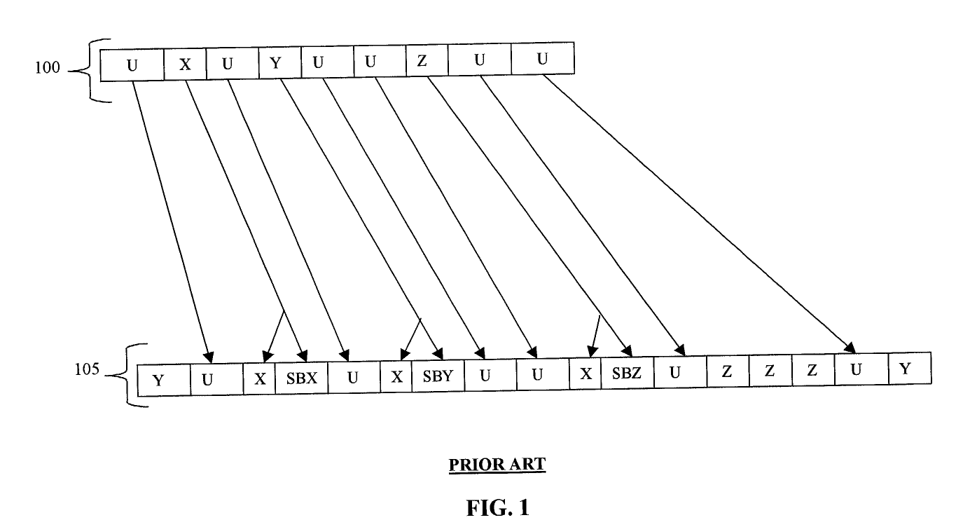

FIG. 2 illustrates a block diagram of a system to generate and transmit frames of data from a transmitting device to a receiving device according to an embodiment of the invention;

FIG. 3 illustrates a data frame generated from a data stream according to an embodiment of the invention;

FIG. 4 illustrates an original character and a stuffed character according to an embodiment of the invention;

FIG. 5A illustrates a process utilized to insert data frames into a data stream according to an embodiment of the invention;

FIG. 5B illustrates an alternative process utilized to insert data frames into a data stream according to an embodiment of the invention; and

FIG. 6 illustrates a process utilized to extract data frames from a data stream according to an embodiment of the invention.

### DETAILED DESCRIPTION

An embodiment of the invention is directed to a system, method and apparatus that generates, transmits and receives frames of data using High-level Data Link Control (HDLC) or a protocol compatible with HDLC. Frames are created from characters in an input data stream. When the characters in the input data stream are equivalent to “special,” or predetermined frame characters (such as the flag character or the ESC character, as discussed below), such input data characters must be altered from their present state. The “special characters” may also be known as “control characters,” “control bytes,” or “control octets.” An embodiment is directed to minimizing the number of special characters used in the frame, and inserting a special filler character into the frames when needed to avoid frame abortion.

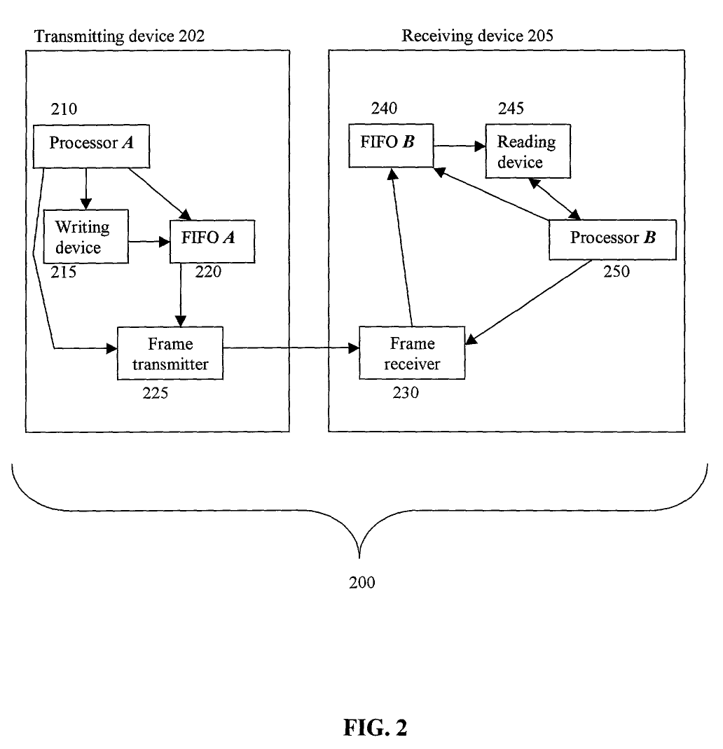

FIG. 2 illustrates a block diagram of a system 200 to generate and transmit frames of data from a transmitting device 202 to a receiving device 205 according to an embodiment of the invention. The transmitting device may include a controller or microprocessor, such as processor “A” 210. The processor “A” 210 may control devices in the transmitting device 202 such as a writing device 215, a First-In-First-Out (FIFO) “A” 220, and a frame transmitter 225. In an embodiment of the invention, the writing device 215 creates frames of data to transmit. The frames may be created from data supplied to the writing device 215 by processor “A” 210. Alternatively, the data may be supplied from a different input source. The alternative input source may be controlled by processor “A” 210 or may be controlled by itself or a controller located outside of the transmitting device 202, for example. FIFO “A” 220 receives the frames from the writing device 215, and may store the frames in an internal queue. FIFO “A” 220 serves to isolate the frequency at which frames are written by the writing device 215 and the frequency at which frames are transmitted across the network. FIFO “A” 220 outputs the frames from its internal queue to frame transmitter 225. The frame transmitter 225 may be a Ethernet card, an Infiniband device, or a modem, for example. The frame transmitter 225 may transmit the frames from the transmitting device 202 across the system to the receiving device 205. The system may be a Local Area Network (LAN), a Wide Area Network (WAN), or the Internet, for example.

The receiving device 205 may include a frame receiver 230 to receive the frame from the transmitting device 202. The receiving device 205 may include several devices controlled by a controller or processor, such as processor “B” 250. Processor “B” 250 controls each of the frame receiver 230, a FIFO “B” 240, and a reading device 245. FIFO “B” 240 has a function of receiving frames from the frame receiver 230 and outputting the frames to the reading device 245. The line frequency at which the frames are received by FIFO “B” 240 may be different than the frequency at which the frames are outputted by FIFO “B” 240 and processed by the 5 system. FIFO “B” 240 serves to isolate the line frequency from the frequency at which the receiving device 205 processes the frames. The reading device 245 may be an Application Specific Integrated Circuit (ASIC), for example. The reading device 245 has a function of extracting data from frames and outputting a data stream to another device, for example. As illustrated, the reading device 245 outputs the data stream to processor “B” 250. However, in other embodiments, the reading device may output the data stream to another device within the receiving device 205.

In the transmit direction, packets are written into FIFO “A” 220 through the system interface at the system frequency and are read from FIFO “A” 220 in the order in which they are processed and mapped into SONET/SDH payloads at the line frequency.

In the receive direction, packets are extracted from the SONET/SDH payload and written into FIFO “B” 240 at the line frequency. An upper layer device connected to the system interface reads the FIFO “B” 240 at the system frequency. FIFOs “A” 220 and “B” 240 are utilized to isolate system and line clock frequencies and provide a mechanism to filter traffic bursts.

In the transmit direction, under some circumstances, FIFO “A” 220 may underflow. That occurs when processor “A” 210 is in the process of mapping a packet and needs to read data from FIFO “A” 220 when FIFO “A” 220 is empty.

Byte-oriented HDLC protocol uses the flag character represented by an eight-bit number to delineate frames. Frames are separated by a flag character. Because the flag character is used for frame delineation, it cannot appear in the frame data. Therefore, whenever “7E”, for example, appears in the frame's data, prior methods substitute “7F” with the sequence “7D 5F” prior to transmission. This is known as byte stuffing.

In an embodiment, the frame transmitter 225 may insert additional information into frames before transmitting the frames to the frame receiver 230. The additional information may include data indicating the start and the end of each frame. Similarly, the frame receiver 230 may receive the frames, extract the additional information, and route the remainder of the frames to FIFO “B” 240.

FIG. 2 shows the frame receiver 230, FIFO “B” 240, reading device 245 and processor “B” 250 as all being part of the receiving device 205. However, other embodiments may include certain components 230, 240, 245, and 250 residing within separate devices other than receiving device 205. Also, other embodiments may include FIFO “A” 220 and the frame transmitter 225 as part of a common device within or outside of the transmitting device 202. Likewise, other embodiments may include FIFO “B” 240 and the frame receiver 245 as part of a common device within or outside of the transmitting device 205.

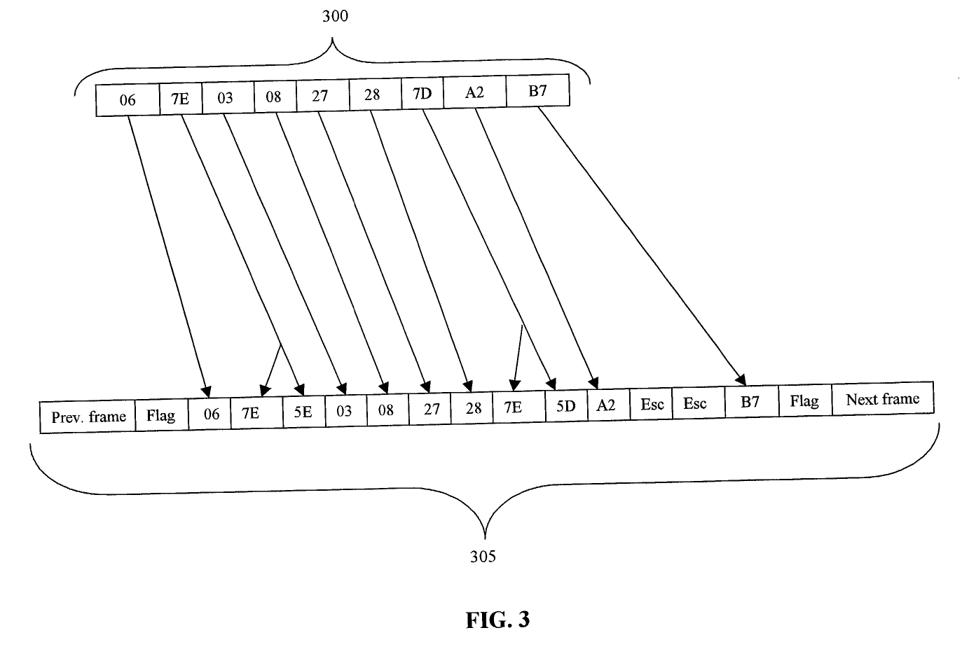

FIG. 3 illustrates a data frame 3 OS generated from a data stream 300 according to an embodiment of the invention. The data stream 300 is formed of a plurality of characters. The 20 characters are formed of a plurality of bits. The characters may be formed of “8” bits, for example. The “8” bits of the character are commonly referred to as a “byte.” The byte “11110101” may be referred to in the hexadecimal (base-16) number system as “F5,” for example. All of the characters may be referred to by their hexadecimal number. “011111110”, or “7E” is commonly used to represent the flag character in a data frame 305. The flag character is used to delineate data frames 305. For example, the flag character may be used to mark the starting point (or ending point) of a data frame 305. “01111101”, or “7D” is commonly used to represent the escape character, or “ESC.” The ESC character, or “7D,” is frequently used in data 5 frames to indicate when a character has been “stuffed.” A stuffed character is a character that has been altered from its original state. For example, if the character “7D” is present in a data stream 300, that character may be stuffed before it can be inserted into a data frame 305. This is necessary because the character “7D” represents the ESC character, which has a special function in the data frame 305 of informing a device receiving the data frame 305 that the next byte in the frame 305 is stuffed. In an embodiment of the invention, the “7E” and “7D” are special characters that may be stuffed before moving from the data stream 300 into a data frame 305. In other embodiments, different bytes other than “7E” and “7D” may be used to represent special characters.

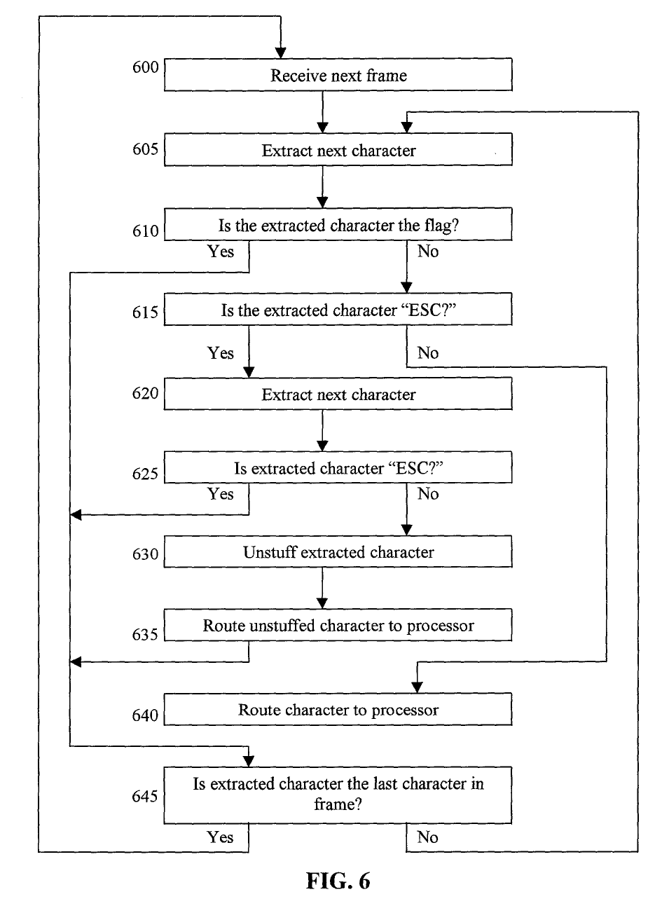

As illustrated in FIG. 3, the data stream 300 includes the following characters: “06 7E 03 08 27 28 7D A2 B7.” The data frames 305 are created from the data stream 300. The data frames 305 include data from a previous frame (i.e., “Prev. frame”), and a flag character to start a frame. As discussed above, the flag character is represented by the character “7E.” After the flag character in the illustrated data frame 305 is the character “06.” The “06” character in the data stream 300 matches up with the “06” in the data frame 305. The characters “03,” “08,” “27,” “28,” “A2,” and “B7” also match up between the data stream 300 and the data frames 305. However, the data bytes “7E” and “7D” is the data stream 300 are stuffed before they can be placed into the data frames. As discussed above, “7E” is stuffed because it is used in a data frame 305 to represent the flag character which is used to delineate each data frame 305. Accordingly, if the data “7E” is present in a data stream used to create a data frame 305, the data is stuffed. If “7E” were not stuffed (i.e., if the data “7E” were inserted directly into the data frame 305 without stuffing), a device receiving the data frame 305 would interpret the “7E” data as the frame delineator, and errors would result. “7D”, which is represents the ESC character, is stuffed for similar reasons. Whereas the occurrence of “7E” represents the flag frame delineation character in a data frame, “7D” is used to notify a device receiving the data frame that the subsequent byte of data is a stuffed byte that needs to be “unstuffed,” as discussed below with respect to FIG. 6.

As illustrated, the data byte “7E” is replaced with the characters “7D” (i.e., “ESC”) and “5E”, and “7D” is replaced with the characters “7D” (i.e., “ESC”) and “5D.” The data frame 305 also includes two “ESC” characters between the “A2” and the “B7” characters. The two consecutive “ESC” characters (i.e., “7D”) are used as fillers to prevent frame abortion due to data underflow. In other words, a delay between the time when the “A2” and “B7” characters are received from the data stream 300 by the writing device 215 may result in the writing device 215 having no data to insert into a data frame 305. The system prevents frame abortion by inserting the two “ESC” characters into the frame 305. The occurrence of two consecutive “ESC” characters is treated as a “NULL,” or as non-data. The consecutive “ESC” characters may be used solely to prevent frame abortion.

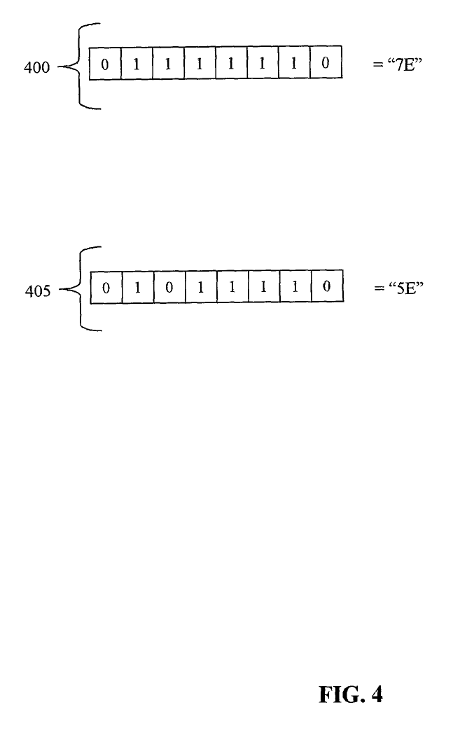

FIG. 4 illustrates an original character 400 and a stuffed character 405 according to an embodiment of the invention. The original character has the following sequence of bits: “01111110,” which is “7E” on the hexadecimal scale. In an embodiment of the invention, the characters are formed of “8” bits, with the left-most bit referred to as the “7th” bit, and the rightmost bit referred to as the “0th” bit. In an embodiment of the invention, the “5th” bit (i.e., the 3rd bit from the left) of the original character 400 is inverted to form the stuffed character 405. Inverting the 5th bit results in the sequence “01011110,” or “5E.” Similarly, if the original character had been “7D,” or “01111101,” its corresponding stuffed character would have been “5D,” or “01011101.” In other embodiments, bits other than, or in addition to, the 5th bit may be inverted.

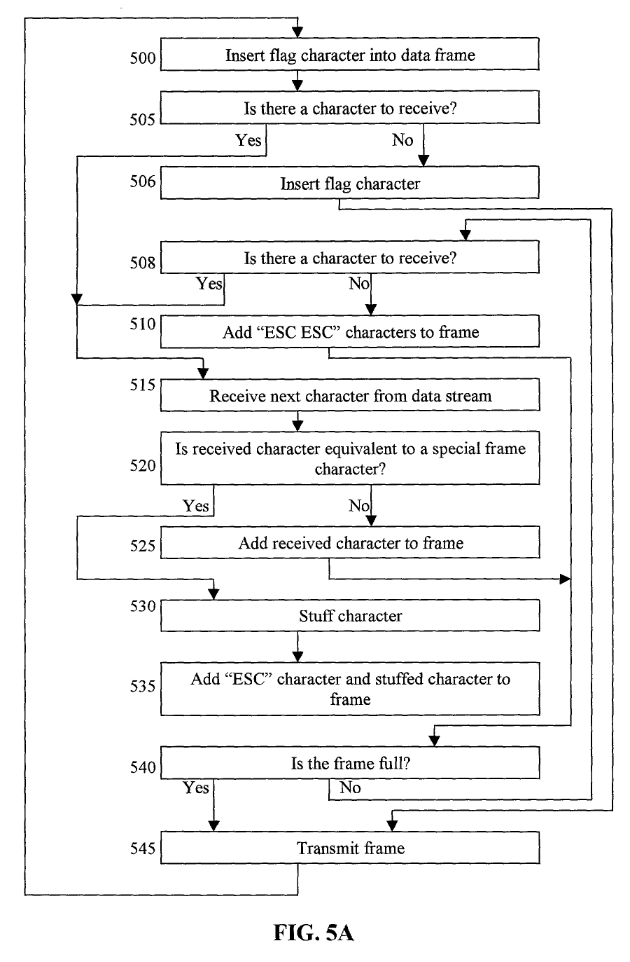

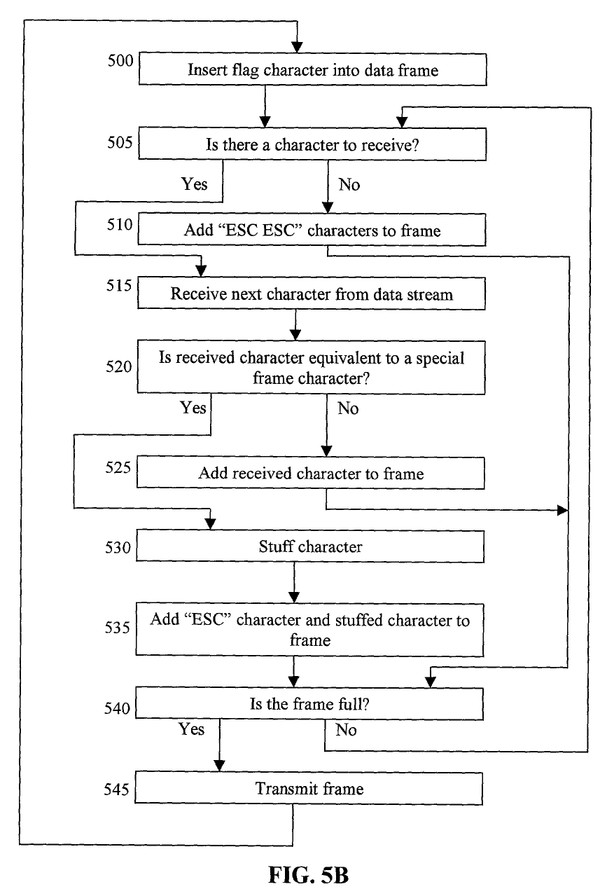

FIG. 5A illustrates a process utilized to create data frames 305 from a data stream 300 according to an embodiment of the invention. Initially, a flag character (i.e., “7E”) is inserted 500 into the data frame 305. The flag character is utilized to signify the beginning of a data frame 305. As discussed above with respect to FIG. 2, other embodiments may use the flag character to signify the end of the data frame 305. In other embodiments, a number other than “7E” may be utilized to represent the flag. Next, the processing determines 505 whether there is a character to receive 505. There is a character to receive if data from the data stream 300 is present. If there is a character to receive, processing proceeds to step 515. Otherwise, processing continues to step 506, where a flag character is inserted into the data frame 305. Since there are now two consecutive flag characters in the data frame 305, the data frame 305 is complete. A data frame 305 having two consecutive flag characters is known as an “empty frame” containing no data. Processing then proceeds to step 545, where the empty frame is transmitted.

At step 515, the next character is received from the data stream 300. If the received character is determined 520 to be equivalent to a special frame character (i.e., “7E” or “7D”), then processing proceeds to step 530, where the character is stuffed. If not equivalent to a special character, the received character is added 525 to the frame, and processing proceeds to step 540. After step 530, the “ESC” character (i.e., “7D”) and the stuffed character are added 535 to the frame. Next, the system determines 540 whether the data frame 305 is full (data frames 305 may have a predetermined size). If the data frame 305 is not full, processing proceeds to step 508, where the system determines whether there is a character to receive. If “yes,” processing continues to step 515. If “no,” processing proceeds to step 510. At step 510, the character string “7D 7D” (i.e., “ESC ESC”) is added 510 to the frame 305, and processing proceeds to step 540. The string “7D 7D” is simply used as a filler to prevent frame abortion. Processing then proceeds to step 540.

At step 540, the system determines the data frame 305 is not full, processing continues to step 545, at which point the data frame 305 is transmitted. Processing then proceeds to step 500.

In an embodiment where data frames 305 of variable sizes are utilized, additional information may be written into each of the data frames 305 to delineate them. The additional information may include data indicating the start and the end of each of the data frames 305. If finished, the data frame 305 is transmitted 545, and the process repeats from step 500. If not full, the process repeats, beginning at step 505.

FIG. 5B illustrates an alternative process utilized to create data frames 305 from a data stream 300 according to an embodiment of the invention. The process shown in FIG. 5B allows filler characters (i.e., the “ESC ESC” characters) to be added to the beginning of the data frame 305 rather than simply generating an “empty frame” when no data is received at the beginning of the data frame 305. In other words, after the flag character is inserted 500 into the data frame, even if there are no more characters to receive, the an empty frame is no transmitted. Instead, the filler characters are inserted into the beginning of the data frame 305, after the initial flag character. The process shown in FIG. 5A, on the other hand, would transmit an empty frame if no data were received after the initial flag character had been inserted 500 into the data frame 305.

The main difference between the process shown in FIG. 5B and that shown in FIG. 5A handles the situation where no data is received immediately after the initial flag character has been inserted 500 into the data frame. Accordingly, the process shown in FIG. 5B lacks steps 506 and 508 of the process shown in FIG. 5A. Also, steps 510-545 are identical in the processes illustrated in FIGS. 5A and 5B, with the exception of step 540. If the data frame 305 is determined to be full at step 540 in FIG. 5B, processing proceeds to step 505 (rather than the step 508 in FIG. 5A).

FIG. 6 illustrates a process utilized to create data frames 305 from a data stream 300 according to an embodiment of the invention. First, a frame 305 is received 600 by the receiving device 205. Next, the next character is extracted 605 from the data frame 305. If the extracted character is determined 610 to be the flag character (i.e., “7E”), processing proceeds to step 645. If not, the process next determines 615 whether the extracted character is the “ESC” character (i.e., “7D”). If it is, the next character is extracted 620. If it is not, processing proceeds to step 640. If the next extracted character is determined 625 to also be the “ESC” character, the process concludes that the consecutive “ESC” characters represent a NULL, and processing proceeds to step 645. If not, then the process concludes that the character is a stuffed character, and the character is unstuffed 630. The unstuffed character is then routed 635 to the processor (e.g., processor “B” 250). Processing then proceeds to step 645. At step 640, the character is routed to the processor, and processing proceeds to step 645, where the system determines whether the extracted character is the last character in the data frame 305. If “yes,” processing reverts to step 600. If “no,” processing reverts to step 605.

The method shown in FIG. 6 is application regardless of whether the method shown in FIG. 5A or the method shown in FIG. 5B is utilized to generate the data frame 305. This is the case because if data frame is received having consecutive flag characters, the system will determine that the second incidence of the flag character is the last character of the data frame 305 at step 645, and processing will proceed to step 600, where the next data frame is received 600.

Therefore, as described above, an embodiment of the invention is directed to a system, method and apparatus that generates, transmits and receives data frames 305 using High-level Data Link Control (HDLC) or a protocol compatible with HDLC. Frames are created from characters in an input data stream. When the characters in the input data stream are equivalent to “special,” or predetermined frame characters (such as the flag character or the ESC character), such input data characters are altered from their present state. An embodiment is directed to minimizing the number of special characters used in the frame, and inserting a special filler character into the frames when needed to avoid frame abortion.

While the description above refers to particular embodiments of the present invention, it will be understood that many modifications may be made without departing from the spirit thereof The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A system to generate and transfer data frames, comprising:
an input source to provide input characters to transmit;
a frame writing device to generate the data frames having the input characters, stuffed characters, and non-data characters, wherein the frame writing device inserts the stuffed characters into the data frames in place of the input characters that are identical to predetermined special characters, and no more than two different special characters are utilized;
a frame transmitting device to transmit the data frames;
a frame receiving device to receive the data frames; and
a data extraction device to extract the input characters from the data frames, wherein the data extraction device extracts the input characters from the stuffed characters.

2. The system of claim 1, wherein the predetermined special characters include a flag character to delineate the data frames.

3. The system of claim 1, wherein the predetermined special characters include an escape (ESC) character utilized to stuff the input characters.

4. The system of claim 1, wherein the data frames are transmitted via High-level Data Link Control (HDLC).

5. The system of claim 1, wherein the data frames are transmitted via Synchronous Optical NETwork (SONET).

6. The system of claim 1, wherein the input characters and the stuffed characters are each formed of a predetermined number of bits, and the stuffed characters have only one bit that differs from the input characters.

7. The system of claim 1, wherein the system further includes a First-In-First-Out buffer to receive the data frames from the frame writing device and to output the data frames to the frame transmitting device.

8. A method of generating frames of data, comprising:
receiving input characters from an input data source;
creating stuffed characters to replace the input characters that are equivalent to special characters in a data frame, wherein no more than two special characters are utilized;
adding the stuffed characters and the input characters that differ from the special characters, to the data frame; and
adding filler characters to the data frame when an insufficient amount of the input characters have been received.

9. The method of claim 8, further including transmitting the data frame to a separate device.

10. The method of claim 8, wherein the special characters include a flag character to delineate the data frames.

11. The method of claim 8, wherein the special characters include an escape (ESC) character utilized to stuff the input characters.

12. The method of claim 8, wherein the frames of data are transmitted via High-level Data Link Control (HDLC).

13. The method of claim 8, wherein the frames of data are transmitted via Synchronous Optical NETwork (SONET).

14. The method of claim 8, wherein the input characters are formed of a predetermined number of bits.

15. The method of claim 14, wherein the stuffed characters have only one bit that differs from the input characters.

16. An apparatus to generate and transfer data frames, comprising:
an input source to provide input characters to transmit;
a frame writing device to generate data frames having of the input characters, stuffed characters, special characters, and filler characters, wherein the frame writing device inserts the stuffed characters and special characters in place of the input characters that are identical to predetermined special characters, and inserts filler characters when insufficient input characters are provided by the input source, and no more than two different special characters are utilized; and
a frame transmitting device to transmit the data frames.

17. The apparatus of claim 16, wherein the predetermined special characters include a flag character to delineate the data frames.

18. The apparatus of claim 16, wherein the predetermined special characters include an escape (ESC) character utilized to stuff the input characters.

19. The apparatus of claim 16, wherein the frames of data are transmitted via High-level Data Link Control (HDLC).

20. The apparatus of claim 16, wherein the frames of data are transmitted via Synchronous Optical NETwork (SONET).

21. The apparatus of claim 16, wherein the input characters are formed of a predetermined number of bits.

22. The apparatus of claim 21, wherein the stuffed characters have only one bit that differs from the input characters.

23. An apparatus to receive data frames and extract data from the data frames, comprising:
a reception device to receive the data frames; and
a frame reading device to extract data from the data frames, wherein the data frames include data characters, stuffed characters, special characters, and filler characters, and the data characters are output in a data stream, the stuffed characters are unstuffed and output in the data stream, the special characters and filler characters are discarded, and no more than two different non-data characters are utilized.

24. The apparatus of claim 23, wherein the special characters include a flag character to delineate the data frames.

25. The apparatus of claim 23, wherein the special characters include an escape (ESC) character utilized to stuff the input characters.

26. The apparatus of claim 23, wherein the frames of data are transmitted via High-level Data Link Control (HDLC).

27. The apparatus of claim 23, wherein the frames of data are transmitted via Synchronous Optical NETwork (SONET).

28. The apparatus of claim 23, wherein the input characters are formed of a predetermined number of bits.

29. The apparatus of claim 28, wherein the stuffed characters have only one bit that differs from the input characters.

30. A machine code storage device, comprising:
a machine-readable medium; and
a machine-readable program code, stored on the machine-readable medium, having instructions to
receive input characters from an input data source,
create stuffed characters to replace the input characters that are equivalent to special characters in a data frame, wherein no more than two special characters are utilized,
add the stuffed characters and the input characters that differ from the special characters to the data frame, and
add filler characters to the data frame when an insufficient amount of input characters have been received.

31. The machine code storage device of claim 30, wherein the machine-readable program code further includes instructions to transmit the data frame to a separate device.

32. The machine code storage device of claim 30, wherein the special characters include a flag character to delineate the data frames.

33. The machine code storage device of claim 30, wherein the special characters include an escape (ESC) character utilized to stuff the input characters.

34. The machine code storage device of claim 30, wherein the frames of data are transmitted via High-level Data Link Control (HDLC).

35. The machine code storage device of claim 30, wherein the frames of data are transmitted via Synchronous Optical NETwork (SONET).

36. The machine code storage device of claim 30, wherein the input characters are formed of a predetermined number of bits.

37. The machine code storage device of claim 30, wherein the stuffed characters have only one bit that differs from the input characters.
